(19) United States
(12) Patent Application Publication
(10) Pub. No.: US 2016/0232497 A1
(43) Pub. Date: Aug. 11, 2016

(54) Geo Location Based Activity Partner Matching Platform

(71) Applicant: Stefanie Jewett, Washington, DC (US)

(72) Inventor: Stefanie Jewett, Washington, DC (US)

(21) Appl. No.: 15/015,579

(22) Filed: Feb. 4, 2016

Related U.S. Application Data
(60) Provisional application No. 62/112,397, filed on Feb. 5, 2015.

(51) Int. Cl. G06Q 10/10; G06Q 50/00

(52) U.S. Cl. CPC G06Q 10/1095; G06Q 50/01

(57) ABSTRACT

A geo-location-based activity partner matching platform may be enabled to determine profile data for a first user; process the profile data based on matching rules, the matching rules being configured to determine a likelihood of matching interest among a plurality of users; determine at least one second user with interests matching to the first user; notify the first user of the at least one second user; and enable the first user and the at least one second user to schedule activities to be performed with each other.

### RELATED APPLICATION

Under provisions of 35 U.S.C. §119(e), the Applicant claims the benefit of U.S. provisional application No. 62/112,397 filed Feb. 5th, 2015, which is incorporated herein by references.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to matching individuals for activities.

### BACKGROUND

Individuals often need or desire a partner for engaging in certain activities. For instance, some people may, at times, prefer to go for a jog with a partner rather than jogging as a solo endeavor. Conventionally, individuals may find such partner within his or her social circle interested in the same activity or join an applicable social organization or club. This can be limiting, as social circles consist of a relatively small pool of individuals, and the option to join an organization or club may be expensive or unavailable.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A geo-location-based activity partner matching platform may be enabled to determine profile data for a first user; process the profile data based on matching rules, the matching rules being configured to determine a likelihood of matching interest among a plurality of users; determine at least one second user with interests matching to the first user; notify the first user of the at least one second user; and enable the first user and the at least one second user to schedule activities to be performed with each other.

Consistent with embodiments of the present disclosure, the profile data may comprise at least one of the following: a name, an age, a location, a gender, at least one activity of interest, a proficiency and frequency of engagement in such activities, and at least one photo. In some embodiments, the profile data may be determined based on the first user's answers to a questionnaire. In yet further embodiments, the profile data comprises receiving the profile data from a third party platform comprising information associated with the first user.

Once matching users have been determined, the platform may display the match results based on, for example, the first user's proximity to the at least one second user. The first user may view the profile data associated with the at least one second user. If interested, the platform may enable a communication between the first user and the at least one second user.

Still consistent with embodiments of the present disclosure, facilitating the communication may provide an interface that enables the first user and the at least one second user to schedule activities that may be of interest. The interface may, for example, provide the matching users with a listing of activities that may be of mutual interest. The listing of events may comprise up-to-date events, activities, and venues. In some embodiments, the platform may provide relevant tips, articles, pictures and information specific to the scheduled activities.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a geo-location-based activity partner matching platform; and

FIG. 3 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of activities, embodiments of the present disclosure are not limited to use only in this context.

I. Platform Overview

Consistent with embodiments of the present disclosure, a geo-location-based activity partner matching platform may be provided. This overview is provided to introduce a selection of concepts in a simplified form that are further described below. This overview is not intended to identify key features or essential features of the claimed subject matter. Nor is this overview intended to be used to limit the claimed subject matter's scope.

The geo-location-based activity partner matching platform may be used by individuals to match with other individuals based on predetermined criteria in order to perform activities (e.g. working out, hiking, biking, walking, tai chi, yoga, pick up or pick-up basketball) together.

The platform may enable users to create a profile. Their profile may include user information such as, for example, name, age, location, gender, activity or activities of interest, proficiency and frequency of engagement in such activities, and photos. The platform may then match the user with other platform users based on the users' mutual interests. The platform may enable its users to search for other users with matching interests based on the users' proximity to each other. Each platform user may read their matches' profiles and message those users that they may want to meet.

Unlike traditional match-making platforms, a platform consistent with embodiments of the present disclosure may enable users to schedule activities of mutual interest. For example, upon providing the platform with an indication that one user would like to meet another user, the platform may provide the user with a listing of activities that may be of interest. The listing of activities may be an up-to-date listing of certain events, activities, or venues that may be of interest to the users. In this way, unlike conventional match-making platforms, the platform of the present disclosure may enable users to engage with each other beyond the ordinary textual/media messaging functionality. Moreover, as will be detailed below, the platform may connect users to certain community forums available other users of like interests.

The platform may provide benefits including:
safety for users such as individuals running at night or weightlifters who need someone to “spot them,” as they lift;
convenience, as a user's schedule may require the activity to be done at a time that no one he or she currently knows is available;
companionship, for example, if a user is new to a city/locale—has just moved there or in-town on business—and doesn't know anyone to perform the activity with;
motivation, for example, if a user needs the accountability of another person to help propel him or her to continue the activity (exercising regularly to lose weight) or attain a new goal (push himself or herself harder to reach a certain goal);
enjoyment, as a user may enjoy doing the activity with a partner versus alone or is looking to make a friend/acquaintance with similar interests; and
physical and mental health, as having a partner to do an activity with may make a seemingly arduous, physically taxing, unpleasant activity more enjoyable, thus promoting the users to engage in it more, resulting in better physical health, as well as mental health as studies show physical activity also helps stave off depression, Alzheimer's disease, dementia and cognitive functionality.

Although the present disclosure references “activities” as, for example, but not limited to, working out, hiking, biking, walking, tai chi, yoga, pick up or pick-up basketball, it should be understood that expansions and modifications to the services rendered are within the anticipated scope of this disclosure.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

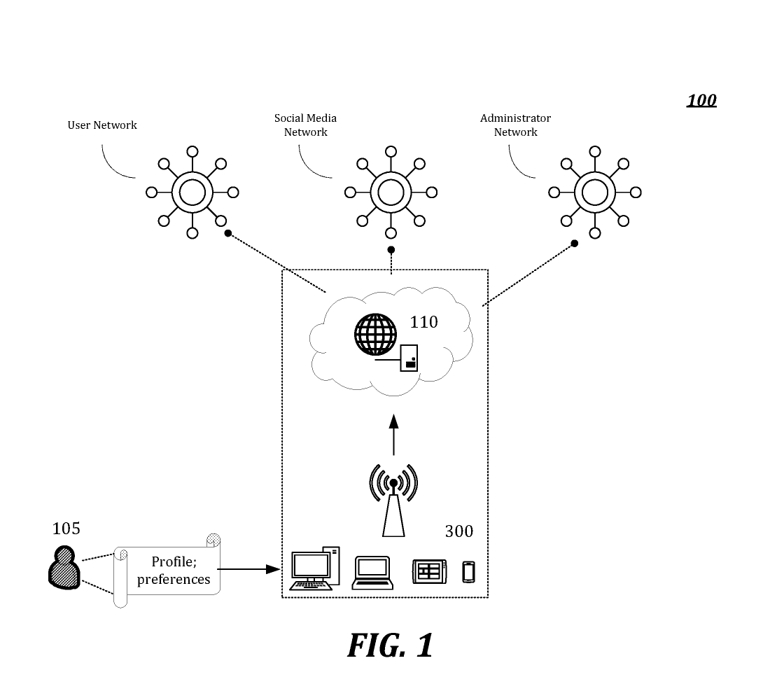

FIG. 1 illustrates one possible operating environment through which a platform consistent with embodiments of the present disclosure may be provided. By way of non-limiting example, a platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 300.

Platform 100 may provide an online interface for enabling users to interact with the platform. Such an online interface may be configured to receive user login and profile information. Further, the online interface may be configured to enable a user to search through his or her matches and interact with matches and others within his or her corresponding community or communities.

Moreover, platform 100 may provide an application interface that may be accessed with devices such as, for example, a desktop, laptop, smartphone or tablet device. The various applications that are adapted to each of these devices may be configured to communicate with server 110 perform the same function as the aforementioned online interface. In embodiments where the device has location tracking technology, the application may provide the platform with location information using location detection methods associated with the device, such as, for example, GPS, Wi-Fi and cell tower triangulation.

In addition to the platform interfacing with users through stand-alone website or application, or it may interface with users through social media as a social media app/plug-in/or software otherwise compatible with a social media Application Programming Interface (API). In this way, employing the API, the platform may retrieve user information (e.g., friends, interests, events, and the like) form a third party social media platform (e.g., Facebook). Furthermore, the platform may interface with users through an administrator platform that may provide additional privileges to administrators.

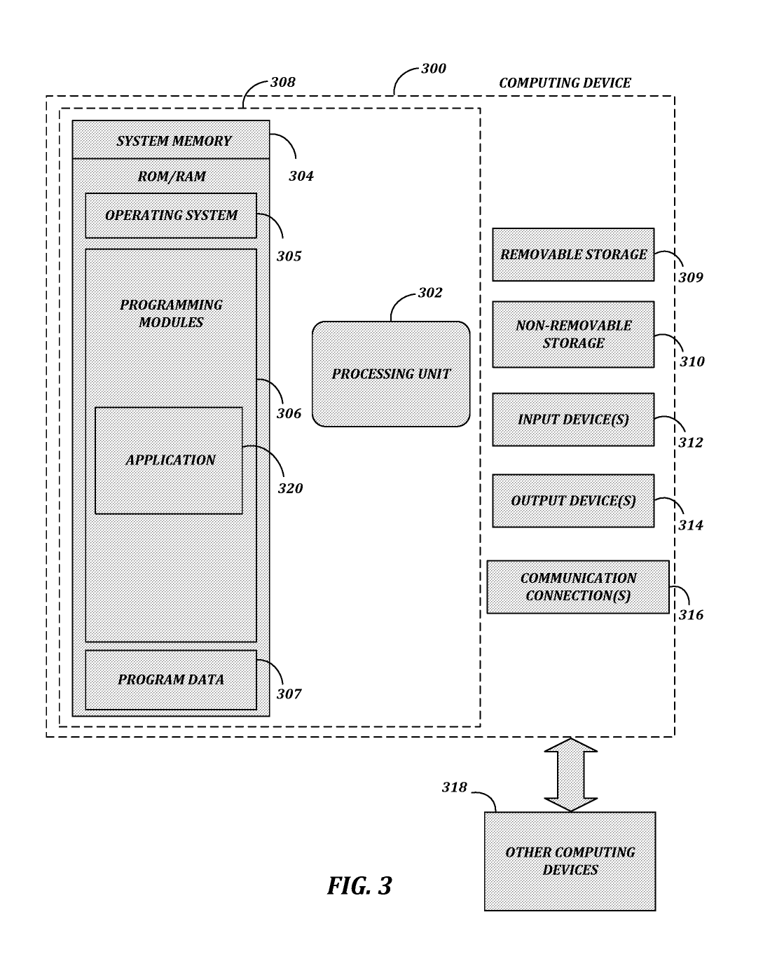

As will be detailed with reference to FIG. 3 below, the computing device through which the platform may be accessed may comprise, but not be limited to, for example, a desktop computer, laptop, a tablet, or mobile telecommunications device. In yet further embodiments, the computing device may comprise a smart-watch or smart-glasses adapted for mobile computing. Though the present disclosure is written with reference to a mobile telecommunications device, it should be understood that any computing device may be employed to provide the various embodiments disclosed herein.

III. Platform Operation

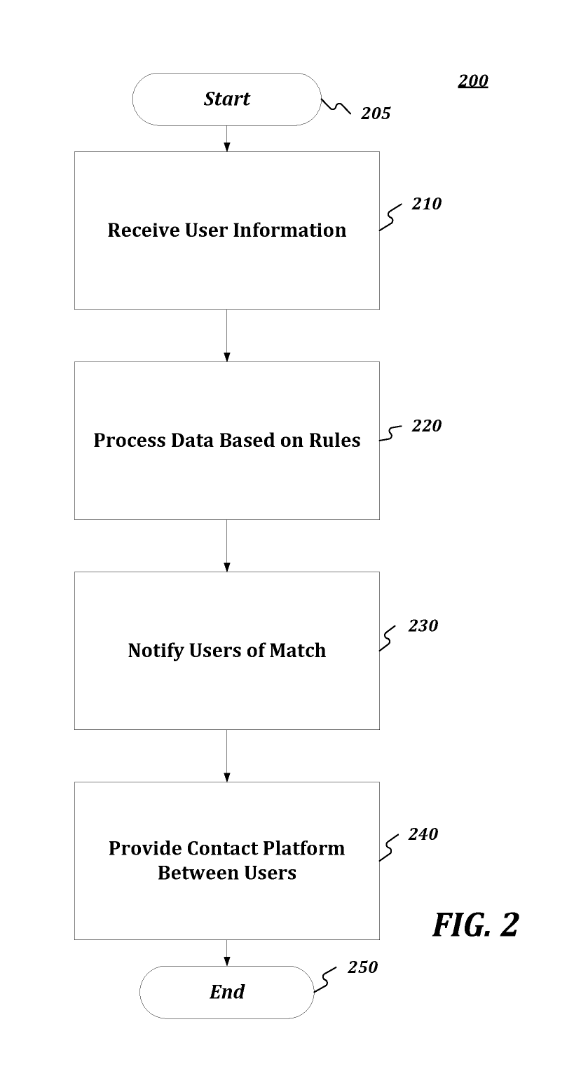

FIG. 2 is a flow chart setting forth the general stages involved in a method 200 consistent with an embodiment of the disclosure for providing platform 100. Method 200 may be implemented using a computing device 300 as described in more detail below with respect to FIG. 3.

Although method 200 has been described to be performed by platform 100, it should be understood that computing device 300 may be used to perform the various stages of method 200. Furthermore, in some embodiments, different operations may be performed by different networked elements in operative communication with computing device 300.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at starting block 205 and proceed to stage 210 where platform 100 may receive user information. For example, a user may create and register a profile. The profile may contain user information such as, for example, name, age, location, gender, activity or activities of interest, proficiency and frequency of engagement in such activities, and photos. The profile may further contain information, such as, for example, contact information, a description of the user, and preferences for potential matches (e.g. location within a specified radius, gender, proficiency, etc.). The platform may receive this information by providing a questionnaire and receiving responses from the user.

In some embodiments, the profile information may be populated from data received from a social media platform. For example, as mentioned above, the platform of the present disclosure may be configured to interface with a third-party social media platform over an API. Employing the API, the platform may retrieve user-data that is available to the social media platform. In this way, the platform user may select to have, for example, their Facebook profile pictures, likes, interests, and friends available for use with the present application.

From stage 210, where platform 100 receives user information, method 200 may advance to stage 220 where platform 100 may process data based on rules. For example, platform 100 may match users based on the extent to which each other's profiles correspond with each user's preferences. Matching rules may comprise excluding users from matches whose profiles do not match each other's preferences. In addition, matching rules may create a “match percent” based on a proprietary algorithm that corresponds to type and quantity of preferences that match between users.

Once platform 100 processes data based on rules in stage 220, method 200 may continue to stage 230 where computing device 300 may notify users of a match. For example, the platform may present on one user's device a list of other matching users. The list may be sorted according to user preferences. Further, the platform may enable the user to select one or more of his matches to receive more information about the selected matches. In addition, the platform may notify a user of a new match, for example, with a message, sound or vibration from his or her device which is connected to the platform 100.

After platform 100 notifies users of a match in stage 230, method 200 may proceed to stage 240 where platform 100 may provide a platform for contact between users. For example, the platform may provide a direct messenger between users. Further, the platform 100 may present the users with information pertaining to their preferred activities, such as, for example, relevant tips, articles, pictures and information specific pertaining to the preferred activity.

For example, the platform may provide a message board for a given activity within a user's preferences (“community”). The message board may enable users to post text, images, videos, etc. as well as view posts by others within their communities. For example, if the matched users selected lift weights/workout as a preference, they may become a part of the “weight lifting community” within the network of other users associated with platform 100 and can share healthy recipes for building muscle mass, articles, tips, advice, personal goals, words of inspiration, exercise ideas, pictures, etc. of interest/relevance to the community, thus allowing for more engagement amongst all the users.

Still consistent with embodiments of the present disclosure, upon providing the platform with an indication that one user would like to meet another user, the platform may provide the user with a listing of activities that may be of interest. The listing of activities may be an up-to-date listing of certain events, activities, or venues that may be of interest to the users. In this way, unlike conventional match-making platforms, the platform of the present disclosure may enable users to engage with each other beyond the ordinary textual/media messaging functionality.

Once computing device 300 provides a platform for contact between users in stage 240, method 200 may then end at stage 250.

IV. Platform Architecture

The platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. It should be understood that, in some embodiments, different operations may be performed by different networked elements in operative communication with computing device 300.

Embodiments of the present disclosure may comprise a system having a memory storage and a processing unit. The processing unit coupled to the memory storage, wherein the processing unit is configured to perform the stages of method 200.

FIG. 3 is a block diagram of a system including computing device 300. Consistent with an embodiment of the disclosure, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the disclosure.

With reference to FIG. 3, a system consistent with an embodiment of the disclosure may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling computing device 300's operation. In one embodiment, programming modules 306 may include user-matching modules, communication modules and interface modules. Furthermore, embodiments of the disclosure may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files maybe stored in system memory 304, including operating system 305. While executing on processing unit 302, programming modules 306 (e.g., user-matching application 320) may perform processes including, for example, one or more of method 200's stages as described above. The aforementioned process is an example, and processing unit 302 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
determining profile data for a first user;
processing the profile data based on matching rules, the matching rules being configured to determine a likelihood of matching interest among a plurality of users;
determining at least one second user with interests matching to the first user;
notifying the first user of the at least one second user; and
enabling the first user and the at least one second user to schedule activities to be performed with each other.

2. The method of claim 1, wherein determining the profile data comprises determining at least one of the following:
a name, an age, a location, a gender, at least one activity of interest, a proficiency and frequency of engagement in such activities, and at least one photo.

3. The method of claim 1, wherein determining the profile data comprises determining profile data based on the first user's answers to a questionnaire.

4. The method of claim 1, wherein determining the profile data comprises receiving the profile data from a third party platform comprising information associated with the first user.

5. The method of claim 1, further comprising displaying match results based on the first user's proximity to the at least one second user.

6. The method of claim 1, further comprising displaying the at least one second user's profile.

7. The method of claim 1, further comprising facilitating a communication between the first user and the at least one second user.

8. The method of claim 7, wherein facilitating the communication enables the first user and the at least one second user to schedule activities that may be of interest.

9. The method of claim 1, wherein enabling the first user and the at least one second user to schedule activities comprises providing the users with a listing of activities that may be of mutual interest.

10. The method of claim 9, where providing the listing of activities comprises providing at least one of the following: up-to-date events, activities, and venues.

11. The method of claim 1, further comprising presenting relevant tips, articles, pictures and information specific to the scheduled activities.

12. A system comprising a memory storage and a processing unit coupled to the memory storage, wherein the processing unit is operative to perform the method of claim 1.

13. A computer-readable medium comprising a set of instructions which, when executed, perform a method comprising:
determining profile data for a first user;
processing the profile data based on matching rules, the matching rules being configured to determine a likelihood of matching interest among a plurality of users;
determining at least one second user with interests matching to the first user;
notifying the first user of the at least one second user; and
enabling the first user and the at least one second user to schedule activities to be performed with each other.

14. The computer-readable medium of claim 13, wherein determining the profile data comprises determining at least one of the following:
a name, an age, a location, a gender, at least one activity of interest, a proficiency and frequency of engagement in such activities, and at least one photo.

15. The computer-readable medium of claim 13, wherein determining the profile data comprises determining profile data based on the first user's answers to a questionnaire.

16. The computer-readable medium of claim 13, wherein determining the profile data comprises receiving the profile data from a third party platform comprising information associated with the first user.

17. The computer-readable medium of claim 13, further comprising displaying match results based on the first user's proximity to the at least one second user.

18. The computer-readable medium of claim 13, further comprising displaying the at least one second user's profile.

19. The computer-readable medium of claim 13, further comprising facilitating a communication between the first user and the at least one second user.

20. The computer-readable medium of claim 13, wherein enabling the first user and the at least one second user to schedule activities comprises providing the users with a listing of activities that may be of mutual interest.
